(19) United States
(12) Patent Application Publication
(10) Pub. No.: US 2011/0191315 A1
(43) Pub. Date: Aug. 4, 2011

(54) METHOD FOR REDUCING NORTH AD IMPACT IN SEARCH ADVERTISING

(75) Inventors: Leonardo Neumeyer, Palo Alto, CA (US); Anish Nair, Fremont, CA (US); Stefan Schroedl, San Francisco, CA (US); Anandsudhakar Kesari, Santa Clara, CA (US)

(73) Assignee: Yahoo! Inc., Sunnyvale, CA (US)

(21) Appl. No.: 12/700,438

(22) Filed: Feb. 4, 2010

(51) Int. Cl. G06F 17/30; G06Q 30/00

(52) U.S. Cl. 707/706; 705/14.42; 707/723; 707/E17.108

(57) ABSTRACT

A method for reducing ad impact on users in a search results page includes receiving a request to deliver ads in response to a search query for display on a search results page; receiving relevance scores for a plurality of ranked web results that are to be served to the search results page; ranking a plurality of ads identified as relevant to the search query according to a position-normalized, click-through-rate metric and bid values, wherein a predetermined number of the top-ranked ads are placeable in a plurality of North ad slots; incrementally and additively placing the placeable ads sequentially according to rank (k) in their respective North ad slots until a utility score generated by a utility function for a current iteration of ads fails to exceed a threshold value; and delivering to the search results page the ads placed in the North ad slots.

### BACKGROUND

1. Technical Field

The disclosed embodiments relate to the service of sponsored search results to the North ad section of a search results page while reducing negative impact on user experience due to their lack of relevance. More particularly, the disclosed embodiments use machine-learned utility models for estimating advertising impact of sponsored search results, employed to decide whether or not to serve particular sponsored search results to the North ad section or, in a multiple cascading auction, to lower East or South ad sections.

2. Related Art

Most current commercial web search engines, such as Yahoo! of Sunnyvale, Calif., generate revenue by displaying advertisements (ads), also referred to as sponsored search results, along with organic web results on search results pages. As shown in FIG. 1, sponsored search results can be served to various regions of the page, including the top (or North), the side (or East), and the bottom (or South) ad positions (or slots). Some ads are now delivered to West side slots as well, which may be treated alternatively as North or side ad slots. In many cases, ads are less relevant and less targeted to the user query than the organic results, which often include more informational results, thus potentially degrading user experience.

Less relevant sponsored search results served to the North ad slots may potentially have a greater negative impact on users because of their prominent position at the top of the page, listed right before or next to the organic—or algorithmically-generated—search results. The North ad slots are typically limited to no more than three or four for at least this reason. These slots are going to prominently capture the attention of users being located in the left triangle of their view. What is needed, therefore, is a system and methods to estimate the impact of ads placeable in North ad slots and to incorporate this estimated impact into the decision of whether or not to display the ads in the North ad slots, or perhaps to push them to the East or South ad slots, thus improving the overall relevancy of the search results page, and consequently user experience.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the present disclosure. In the drawings, like referenced numerals designate corresponding parts throughout the different views.

FIG. 1 illustrates an exemplary search results page including advertisements served with organic search results.

FIG. 2 is a block diagram of an exemplary system for estimating and reducing North Ad Impact of sponsored search results.

FIG. 3 is a flow diagram of an exemplary method for reducing ad impact on users in search advertising.

FIG. 4 is a flow diagram of an exemplary method for executing multiple auctions on advertisements to be served to a search results page.

### DETAILED DESCRIPTION

By way of introduction, included below is a system and methods for estimating advertising (ad) impact of sponsored search results (or advertisements (ads)) caused by less relevant ads proposed for delivery to North ad slots. The system and methods then improve the user experience by using an estimated North Ad Impact (NAI) as a gauge for whether to include certain ads in the North ad slots. Sometimes the decision is between inclusion of the ad in the North as opposed to in the East or South, and sometimes the ad should be completely filtered out and not displayed on a current search results page. That is, the ad, through multiple cascading auctions that includes ranking and filtration steps, should be pushed to subsequent search results pages returned in response to a query.

The prevalent auction model in current web search advertising is based on the generalized second price (GSP) principle. Advertisers bid on search terms relevant to their products. Advertisers have a chance to display their ads on the search engine results page when users type in these queries, along with competing ads and organic web results. The ads are ordered according to a function (rankScore) of bid and an ad quality score (typically a position-normalized estimate of click-through-rate). Click-through-rate (CTR) refers to the number of users that click on a served advertisement, in relation to ad views, and end up on the landing page URL associated with the advertisement. When the user clicks on an ad, the advertiser has to pay a minimum bid (plus some small increment) necessary to retain his rank according to this ordering. While this ranking is geared towards maximizing the expected instant revenue of the search engine, its long-term success also hinges on its utility for all three of the following groups of participants:

Users visiting the search engine for quick navigation, to find information, and to find transactional sites.

Publishers are web sites displaying the search engine results. In addition to the search engine portal itself, third parties can generally enter a revenue-sharing agreement to show the results on their site.

Advertisers try to maximize their return on investment by obtaining a large volume of clicks with lower price than their expected value of conversion.

Some generalized utility frameworks have been proposed in the past. The challenge lies in translating such models into practically feasible adaptations to a current web search advertising system. These changes affect a variety of functions that can be summarized under the name Sponsored Search Optimization and defined as follows:

Ranking orders the ads according to a score of estimated utility.

Pricing determines the cost advertisers have to pay for a click.

Filtering decides which ads out of all candidates are eligible to be shown for a given query.

Page Placement determines where to show ads on the search results page: above (or North) or next to (or West) of the organic results, in a separate column to the right (or East) or below (or South) of the organic search results. Page placement may further include the determination of in which ad slots within the above-described various ad sections (North, East, West, or South) to display an ad.

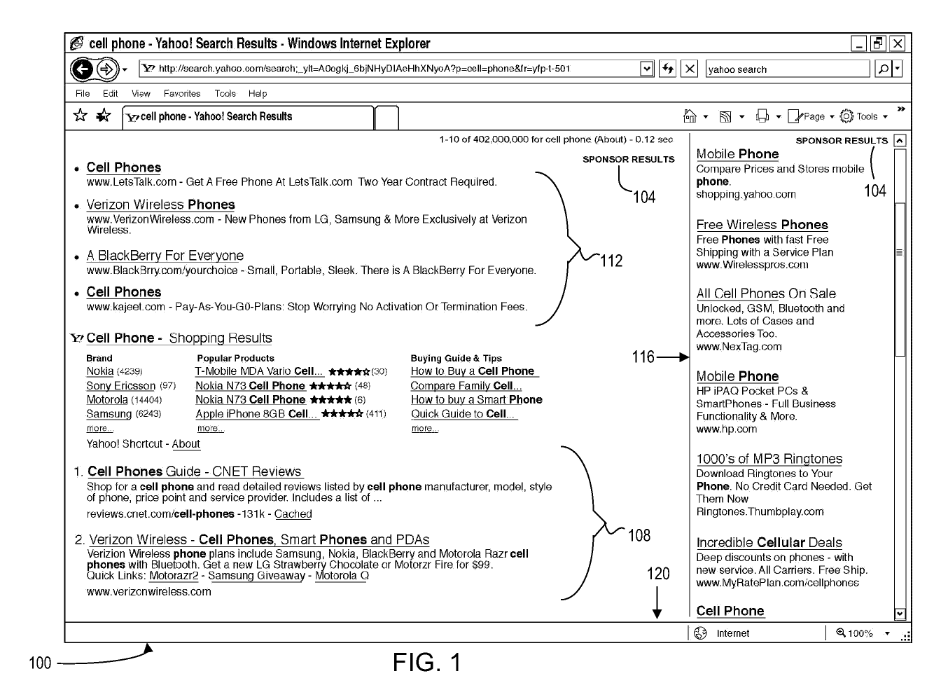

FIG. 1 illustrates an exemplary search results page 100 including sponsored search results 104 (also referred to as advertisements (ads) 104) served with organic search results 108. Ads 104 are sites that pay for placement in search results on keywords that are relevant to their business. Ads 104 are listings that appear on search results pages 100 and other sections of an online service provider. Ads 104 should be relevant to the specific search term(s) used when queried by a user, and are listed separately so they can be distinguished from organic search results 108. As displayed, a search for the keyword “cell phone” returned 402,000,000 results, 10 of which are displayed as organic search results 108 on the search results page 100.

As discussed, the ads 104 are broken into three sections (or regions) representing three cardinal directions: a North ad section 112, an East ad section 116, and a South ad section 120 with respect to the organic search results 108. As previously discussed, but not shown, ads may also be served to the West, or the left, of the organic search results. The ads 104 located at the South section 120 of the results page 100 are not viewable in FIG. 1 but are located beneath the tenth ad of the organic search results 108. Each ad 104 takes a position on the page 100 referred to as an advertisement (or ad) slot. There are a limited number of slots per each search results page 100 across all the ads 104 in the three (or four) cardinal directions, usually totaling about 14 to 15 ads. The number of organic search results 108 are also limited by how many can be practically delivered to and focused on in a page view by a typical computer (or communication device) screen. While the following description is generally drawn to the ads 104, it is also applicable to any other ads delivered to a results page 100 as part of a hierarchal set of results pages in response to a search or browsing action that has the affect of executing a keyword query over the internet or Web. Accordingly, where the term “search result page” is referred to herein, it should be understand to refer to any results page from user searching or browsing actions.

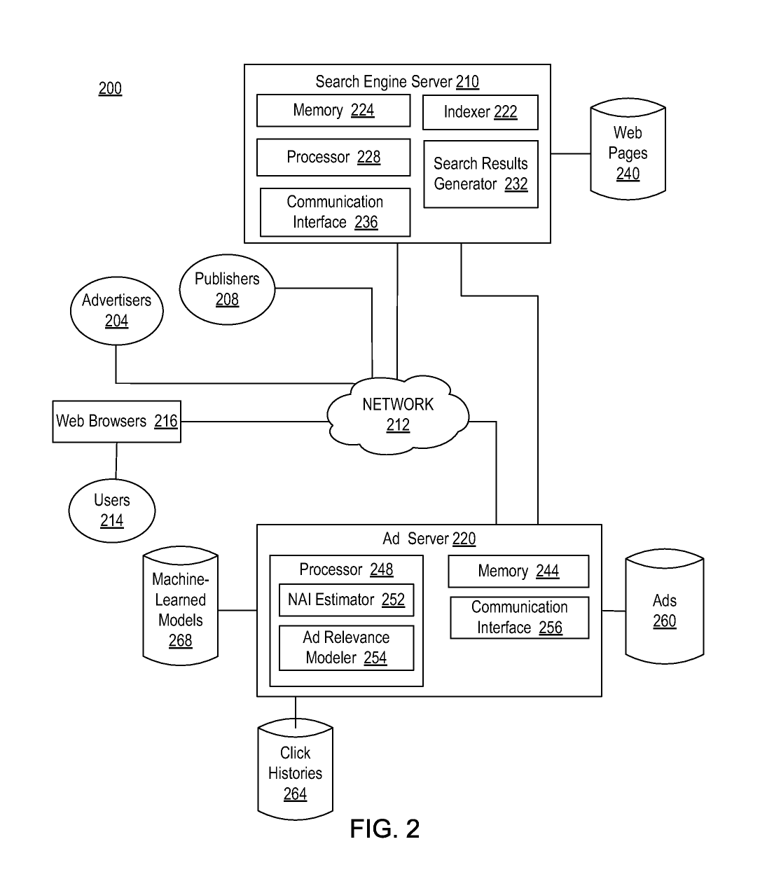

FIG. 2 is a block diagram of an exemplary system 200 for estimating and reducing ad impact of sponsored search results, such as those displayed in FIG. 1. The system 200 brokers advertising between advertisers 104 and publishers 108 through a search engine server 210 (also referred to as, or integrated as a part of, a search web server), which is made available to advertisers 204 over a network 212. The search engine server 210 will also be referred to herein, for simplicity, as a search engine 210, which includes at least the hardware and software components described in more detail below. The network 212 may include the internet or World Wide Web (“Web”), a wide area network (WAN), a local area network (“LAN”), and/or an extranet or other network, connected to through use of either a wired or wireless connection. One or more users 214 may access over the network 212 the search engine 210 via their web browsers 216 on communication devices (not shown).

The system 200 may further include an advertisement (ad) server 220 coupled with the network 212 and directly or indirectly coupled with the search engine server 210. Herein, the phrase “coupled with” is defined to mean directly connected to or indirectly connected through one or more intermediate components. Accordingly, the ad server 220 may be integrated within the search engine server 210, may be local to the search engine server 210, or may be accessible over the network 215. The ad server 220 receives request from the search engine 210 for ads 104 to be delivered, along with the organic search results 108, to a search results page 100 in response to query submitted by a user 214.

The search engine server 210 may include an indexer 222 or the indexer may be executed remotely on another computing device, and be coupled with the search engine 210 over the network 210. The search engine server 210 may further include a memory 224 to store computer code or instructions, a processor 228 to execute the computer code or instructions, a search results generator 232, a communication interface 236, and a web pages database 240. Note that “web pages” and “websites” are intended to be synonymous as used herein. The indexer 222 indexes the web pages of the database 240 according to key word terms that relate to the content of the web pages and that are likely terms to be searched for by the users 214.

The ad server 220 may include a memory 244, a processor 248, which includes at least an North Ad Impact (NAI) estimator 252 and an ad relevance model 254, a communication interface 256, a ads database 260, a click histories database 264, and a machine-learned database 268. Because the ad server 220 may be integrated within the search engine server 210, processor 228 may be same as the processor 258, and may thus execute the same software instructions or code to carry out the embodiments disclosed herein.

The indexer 212 indexes the web pages stored in the web pages database 240 or at disparate locations across the network 215 so that a search query executed by a user will return appropriate organic search results 108. When a search is executed, the search results generator 236 generates organic web results that are as relevant as possible to the search query for display on the search results page 100. Indeed, the search results are ranked according to relevance. Also, when the search query is executed, the search engine 210 requests appropriate ads from the ad server 220 to be served in ad slots of the search results page 100.

Before returning ads in response to the request by the search engine 210, the ad server 220 requests relevance scores for the organic web results from the search engine 210. The ad server 210 also, with its processor 248, determines an incremental ad impact value for each iteration as the ads are incrementally and additively placed in the North ad slots according to rank. Another way of describing ad impact value, which will be discussed in more detail below, includes a difference of relevance between a page displaying ads at ranks 1 through k−1 with a page displaying ads at ranks 1 through k. Accordingly, for example, the relevancy of the search results page with North ad slot 1 filled is compared with the relevancy of the search result page with North ad slots 1 and 2 filled.

In one embodiment, only “placeable” ads are iteratively placed in the North ad slots for determination of the incremental relevancy differences, which are then used along with average expected revenue of the placed ad(s) during each iteration to determine a utility score. Placeable ads are those that would normally be placed in one of the predetermined number of North ad slots (e.g., four), after being ranked according to a position-normalized, click-through-rate metric. The utility score is compared with a threshold value to determine whether the most recently-placed ad (at rank k) should be delivered or not along with all previously-placed ads. In this way, one or more placeable ads may not be delivered to the North ad slots 112, but may be pushed down to an East ad section 116 or a South ad section 120. Choosing the threshold value is a business decision that weighs generating revenue with potentially increasing ad impact on users. The higher the threshold value is chosen, which can be a global threshold value, the fewer ads will be delivered to North ad slots. In contrast, the lower the threshold value chosen, the greater number of ads will be delivered.

The overall page relevance, which can be cast as a relevance score, may be calculated as a weighted average of per-search result score according to the discounted cumulative gain (DCG) framework, which will be discussed in more detail below.

The North Ad Impact (NAI) estimator 252 may further determine an incremental NAIₖ, where k denotes rank, for each iteration of placing an additional ad in a North ad slot, as an extension to the above-described method. More particularly, NAI is the difference between the editorial relevance (DCG) of the search results page with algorithmic results, but without sponsored search results in the North ad slots, minus the editorial relevance (DCG) of the search results page with the sponsored search results in the North ad slots. When the NAI is determined at each iteration of adding, incrementally, additional ads in their ranked (k) positions in the North, it becomes an incremental NAIₖ.

The proposed methods use a machine-learned model to predict the NAI, wherein the models are trained initially through human judges that assign relevancy value to a plurality of features based on editorial data of query/ad pairs. This is the same training procedures as used for web results which target page relevance scores. The editorial data may be derived from thousands of query/ad pairs actually searched for previously by users 214 of the search engine 210. Click histories stored in database 268 provide bucket metrics for relevance filtering, among other uses, as will be discussed below. Click histories, for instance, may provide the following for candidate sets of query/ads: click through rates (CTR); queries with ads (coverage); ads per query (depth); price per click (PPC); clicks per search (click yield); and revenue per search (RPS). At run time, a user-executed query is run through the machine-learned model along with candidate sponsored search results in order to estimate NAI and determine if individual candidate ads should be place in the North ad slots. The NAI estimator 252 executes the model as described below.

The machine-learned models are stored in database 268; the ad relevance model 252 takes data inputted by the human judges and executes the machine-learning that is required to provide the machine-learned models. The communication interfaces 240, 260 enable receiving user queries and sending search results to search results pages to various types of browsers used by various computers and communication devices (not shown) of the users 214. Additional or different hardware may be included and may interact with the processors 228, 258 to execute the embodiments disclosed herein.

As will become apparent, the system 200 disclosed herein can be tuned with the methods disclosed, to place more ads in the North ad slots 112, which results in a higher number of clicks, while keeping NAI low. The result is that advertisers and publishers can increase revenue while not sacrificing user experience and satisfaction. Keeping user experience positive also helps to prevent users from going elsewhere and not consuming advertising because of previous negative or poor experience. More precisely, because NAI is an indirect measure of user experience, the system 200 can generate more clicks without decreasing user experience, or can increase user experience without losing clicks.

The proposed methods require two major components: (1) a machine-learned model to predict relevance of the sponsored and the algorithmic results and (2) a utility function that uses NAI to model the cost of showing ads to the user. With regards to the first component, to predict ad relevance, the system 200 trains machine learning models using human judgments of ad relevance on a data set. To predict web relevance, the system 200 uses raw machine-learned ranking scores from databases of the search engine 210. The web search ranking model was trained with editorial data on the same rating scale, such that the scores are comparable.

With regards to the second component, a utility function is used to determine if a sponsored search result (ad) should be placed in the North. Typically, existing page placement functions use the expected revenue per page view of an ad 104, estimated by multiplying the probability of click on the ad by its bid. Subsequently, all ads that pass a predetermined threshold, and are placeable, are allocated in the North ad slots. Here, placeable denotes the constraints of the page layout in terms of maximum number of ad slots discussed above, and the ad has to be either at the top rank or the next higher ad has to have been already placed. By adjusting the threshold, the average number of North ads per search can be changed.

At least two methods are proposed for incorporating the online NAI estimate into utility functions, outcomes of which determine whether or not to display the placeable sponsored search results in the North ad slots. The first is to subtract the estimated NAI, multiplied by a scaling factor, from the average expected revenue of a current iteration of placed ads 104, as a “relevance discount” to revenue. The average expected revenue value after the “relevance discount” may be termed as a score, which if greater than a predetermined threshold value, the candidate sponsored search results are displayed in a North ad slots. The second is to use the ratio of expected revenue over estimated NAI as the score, which is then compared with the threshold as done in the first method. This second method corresponds to a greedy algorithm that maximizes revenue under the constraint of a maximum average NAI, which can be set by adjusting the threshold. This can be a more accurate measure of user experience than just the average number of ads in the North ad slots.

The effects of ranking and placement of ads on the search result page may be expressed in terms of utility, and may be modeled with utility function. The following is a brief review of the utilities of the different participants in search advertising.

Advertiser Utility: Advertisers 204 try to maximize the number and values of conversions (e.g., purchases). The relative conversion frequency, times the value per conversion, should exceed the price per click (PPC) to be profitable. There is usually a complex and only partially-known relationship between the volume of clicks and the bid: higher bids can secure more prominent placement, but will tend to increase cost dependence on competing ads. Also, the composition of queries and search traffic has a significant effect on conversion rate. If truthful bidding is assumed equal to the click value, ranking by bid times click-through rate guarantees maximization of advertiser value if higher ranks receive more clicks, everything else being equal.

Publisher Utility: Ultimately, publisher revenue is a share of the total conversion value. There are two ways to raise it: by taking share away from advertisers (e.g., through modifications of the rankScore function), or by striving to create more value for advertisers, and then indirectly profiting as a publisher 208. Surely, the latter option is the more sustainable one in the long term. Methods can be employed to increase CTR with no conversion rate change, e.g., by excluding ‘accidental clicks,’ to increase conversion rate, e.g., by better ad targeting to user searches, or both. Since it can be safely assumed that converting users are satisfied, increasing the conversion rate is good for all three groups.

User Utility: Under some assumptions, it is observable that giving most of the clicks to the advertisers 204 with highest ranking score improves their utility and the utility of the publisher 208. However, most users 214 visit the search engine 210 primarily for organic results 108, so a natural conflict in short term utility arises. In the long term, bad ads 104 that tarnish overall user experience and keep them from coming back are detrimental to the search engine 210 as well. The remainder of the disclosure will focus on user utility.

The ultimate measure of user utility is task completion: the user 214 finds the information or web address he was looking for, or a site to execute an intended transaction. It can only be credited to the entirety of the user's goal-related actions, generally not to an individual search result. Without explicit feedback, task completion is hard to recognize. Nevertheless, a number of implicit measures have been developed that correlate to some degree, e.g., click-through rate, landing page dwell time, scrolling actions, conversions, etc. For these reasons, all frameworks have to make strong simplifications in their user models. The following include some common assumptions. (1) The user's task-related activity consists of a single search. (2) There is at most one click per search results page, and it determines success. (3) Results are examined independently of each other. (4) The utility of the result list can be decomposed into a sum of individual result utilities.

Suppose that each search result can be clicked; subsequently, the user 214 examines the landing page, which may or may not be relevant. Depending on these mutually-exclusive cases of user behavior (not seen, not clicked, relevant landing page), the expected user value of an ad can be defined as

Uᵤₛₑᵣ=(1−p(click))·U_{distr}p(click)·(p(rel)·Uᵣₑₗ+(1−p(rel))·Uᵢᵣᵣₑₗ).

Uᵣₑₗ is the utility of a relevant result; p(rel) is the probability of relevance; U_{distr} is the negative utility due to visual distraction and annoyance, e.g., through lowering the probability of noticing other, more relevant results. Uᵢᵣᵣₑₗ is the (even lower) negative utility of the user recognizing that a clicked page does not meet his expectations. The parameters U_{distr}, Uᵣₑₗ, and Uᵢᵣᵣₑₗ have orthogonal definitions and can be estimated independently. They could be refined as a function of the ad, slot, session, etc: Uᵣₑₗ may be higher for more expensive markets; Uᵢᵣᵣₑₗ could be made low for an informational session, and high for commercial sessions; U_{distr} may decrease with rank, and can be a function of the estimated relevance of the shown abstract to the query. The total value of a ad may be defined as the sum of the declared advertiser value, and the estimated user value:

Uₜₒₜₐₗ=p(click)·bid+p(click)·p(rel)·Uᵣₑₗ+p(click)·(1−p(rel))·Uᵢᵣᵣₑₗ+(1−p(click))·U_{distr} ,(1)

which is equivalent to

Uₜₒₜₐₗ=p(click)[bid+p(rel)(Uᵣₑₗ−Uᵢᵣᵣₑₗ)+(Uᵢᵣᵣₑₗ−U_{distr})]+U_{distr} .(2)

User Utility for Ranking and Filtering: In an auction for a single display slot, a direct estimate according to Equation 2 may be used in which the result wins that has the highest score. However, this is not directly applicable to the multi-slot case; since the probably of click, p(click), is dependent, among other factors, on the actual display slot. What is needed is a position-normalized score S so that for all ads a, a′, and positions i, U_{total,i}(a)>U_{total,i}(a′) whenever S(a)>S(a′). It is convenient to assume that the positional effect can be factored both for the click probability and for U_{distr}, in the same way:

p(click|position,ad, . . . )˜f(ad, . . . )·g(position)

U_{distr}˜h(ad, . . . )·g(position).

One interpretation is that g is the probability of the user noticing the ad altogether while scanning the page; this probability is assumed to decrease with rank, independently of the actual ads 104. Under this assumption, it is feasible to use a ranking score that is similar to Equation 2, except that the position-independent estimates p(click|seen) and U_{distr|seen}=U_{distr}/p(seen) replace p(click) and U_{distr}, respectively.

Ranking based on this score results in maximizing the sum of all expected result values. Filtering arises as a natural consequence: it is better not to show a result with negative expected value at all.

User Utility for Page Placement: Advertisements on top—or to the North of—organic results (rather than in a separate, right-hand column) directly compete with the organic results for space. For some commercial search terms, ads can be more attractive than web results, but more frequently, they can divert attention and keep users from reaching pages with the requested information. Real world search engines deliberately risk degradation of user experience in exchange for expected revenue.

Ads not shown in the North ad positions (or slots) can still be shown in the East or in the South; however, the bulk of both user impact and revenue stems from the North ad slots 112. Accordingly, the following analysis focuses first on North ad slots 112.

Deciding ad placement is a task of integrating two completely separate search engines. In principle, Equation 2 could be applied by finding appropriate parameters (higher relevance probabilities and utilities for web results should compensate for the lack of revenue). Out of a set of possible slates of ad and web results, the one that maximizes the total expected utility may be chosen. However, these parameters are hard to estimate accurately. Just relying on the utility estimate for page placement would make it hard to influence parameters like, for instance, the total number of ads directly shown. Therefore, real-world search engines 210 try to get more fine-grained control over the trade-off between revenue and user utility.

Page Placement Algorithm: A target of estimated user utility can be fixed, and then an ad allocation algorithm can be tuned to optimize estimated revenue. First, suppose an offline simulation can be run based on a sample of N historical user searches from server logs in the click histories database 268, together with the corresponding ranked lists of web and ad results. For simplicity, equate user utility with (negative) average number of ads per page, n_{ad} (also called the North Footprint, NFP); so we can allocate n_{ad}N total ads across the given searches. If the ad server 220 could place any available ad, a simple greedy algorithm would find the maximum expected revenue by choosing the top n_{ad}N ads in order of decreasing estimated revenue (more precisely, p(click)·bid). Of course, in reality there are constraints to be observed: the maximum allowable number of North ads and the ranking. The greedy algorithm can be refined to take care of these dependencies; if the ranking score is different from the page placement objective, this strategy is not guaranteed to find the optimal result any more, but acceptable performance has been observed in practice.

Note that the placement would have been the same as if it had been done online by the search engine server 210 executing the following algorithm: allocate each placeable ad whose expected revenue is at least as large as that of the (n_{ad}N)-th top ad. Now, as a generalization, suppose the object is to maximize revenue under a constraint of an arbitrary utility function, not only the total number of ads as above. It is easy to see that, even in the offline scenario without constraints, an instance of the NP-hard 0-1-knapsack problem is presented. M. R. Garey and David S. Johnson, Computers and Intractability: A Guide to the Theory of NP-Completeness, W. H. Freeman, 1979. Clearly, a greedy online algorithm is preferred: first to consider utility cost, and then allocate placeable ads in this order until the overall utility budget is exhausted. For instance, current page placement may be such as to maximize revenue by placing North ads over all, or a representative sample of searches, given a budget based on average user impact. The algorithm is made greedy, to thus select items in decreasing order of value, or value/cost, or some other similar value metric. The method stops placing ads when the budget is reached.

One way of measuring the web search retrieval quality that has become somewhat of a standard is the Discounted Cumulative Gain (DCG). Kalervo Järvelin and Jaana Kekäläinen, Cumulated gain-based evaluation of IR techniques, ACM Trans Inf. Syst., 20(4):422-446, October 2002. This is a weighted sum of the relevance (according to human judges) of the top p returned documents, where the weight is a decreasing function of the rank:

$${DCG}_{p} = {\sum }_{i = 1}^{p} {w}_{i} \cdot {rel}_{i}$$

This formula is also commonly used with non-linearly graded relevance scores. The reasoning behind the weights is that according to behavioral studies, users spend a limited amount of effort on scanning the SERP, with most of their attention focused on a top left triangle. A popular choice for the position weight is wᵢ=log₂(1+i).

DCG can be viewed as a special case of Equation 2 as follows: the position weights wᵢ correspond to p(click)˜const*p(seen), e.g., the user clicks blindly on results with a probability decreasing with the rank. The relevance score relᵢ is an aggregate estimate of the expected total post-click value, (p(rel)·Uᵣₑₗ+(1−p(rel)·Uᵢᵣᵣₑₗ)), and U_{distr}=0.

For a given search results page consisting of ad and web results, this DCG measure may be used to determine relevance degradation. North Ad Impact (NAI) is defined as the difference in DCGₚ for the whole page (including top ads), and for the same page with the ads removed.

Using NAI for Page Placement: Editorial data is sparse, so approximations and predictions are employed. Let the incremental NAI of the ad at rank k be defined as the difference of the DCGₚ of the search results page with ads 1, . . . , k−1 shown, minus that of the same page with ads 1, . . . , k:

$${NAI}_{k} = {\sum }_{i = 1 … p - k} ( {w}_{k + i - 1} - {w}_{k + i} ) \cdot {rel}_{wed , i} + {w}_{p} \cdot {rel}_{web , p - k} - {w}_{k} \cdot {rel}_{ad , k} . \qquad ( 3 )$$

That is, all web results get pushed down one rank (and thus suffer a loss in DCG weight) except for the last, vanishing result at rank p. Under the simplifying assumption that all web results are equally relevant (relweb;i=relweb), NAIₖ results in

NAIₖ=wₖ·(rel_{web}−rel_{ad,k}). (4)

The incremental NAIₖ estimate can be used by ordering ads for page placement not only by estimated revenue as before, but by a North ad placement (NAP) score that is discounted by the NAI. There are at least two ways of using the incremental NAIₖ to adjust a NAP or utility score. The first, as mentioned, is to discount the utility score, which may include expected revenue of the last-placed ad. The utility score may also include probability of click or bid value multiplied by the probability of click, or other similar metric. Accordingly, if expected revenue is used to generate the utility score, then the expected revenue minus the NAIₖ value at ad of rank k becomes the utility score that is compared against a threshold value to see if the last-placed ad will be delivered or not. Use of the threshold value was discussed in detail above. The second method is to calculate the utility score as the ratio of expected revenue—or other similar metric—divided by the estimated NAIₖ. This utility score is then directly compared with the threshold value as was the expected revenue, discounted by the NAIₖ, before to determine if the last-placed ad will or will not be delivered.

Multiple Cascading Auctions: As explained above, practical implementations of ranking and filtering in the second-price auction require the score function to depend on display-position only in a very simple, multiplicative way. One way to achieve such flexibility is to have multiple auctions using potentially different utility functions. If there is a natural ordering of page regions, the ad server 220 can auction off the one with the highest value first, then run an auction for the next highest value with the advertisers 204 that did not win a placement in the first round, and so on. The algorithm for the case of the North and East regions is given below in Table 1. This algorithm can be generalized in which the North auction is a first auction in any ad section and the East auction is a second auction in any second ad section different than the ad section.

TABLE 1

| | |
|---|---|
| 1. North | (a) Rank all candidate ads according to the North ranking score. |
| Auction | (b) Compute NAP scores for the remaining ordered list |
| | (using the same or a different function). |
| | (c) Filtering: Remove ads with a negative score. |
| | (d) Compute the costs as in the General Second Price auction. |
| | (e) Remember only the winning North ads (if any). |
| 2. East | (a) All ads that did not get allocated in the North slots form |
| Auction | the set of East candidates. |
| | (b) Rank all East candidates according to the East ranking score. |
| | (c) Compute NAP scores. |
| | (d) Filter ads with negative score. |
| | (e) Compute the costs as in the General Second Price auction. |

3. Merge the ranked North ads with the ranked East ads to form final
ranking.

The most drastic change is the ability to ‘skip’ to the North, by-passing other ads in the East that might have a higher ranking effective cost per mill (eCPM), but are not deemed relevant enough. Therefore, it can alleviate the “coat-tail effect” of the page placement algorithm, discussed above, that occurs in case of disparity of ranking and NAP score.

One interesting special case of the dual-auction scheme is to use it only to restrict the set of North candidates, but otherwise not change the ranking and page placement from the single-auction case. This could be formalized by adding a term to the utility score that is −∞ for an ad in a North auction that does not meet a given relevance estimate threshold, and zero otherwise. This is analogous to the concept of risk aversion from social sciences, which is commonly modeled as a non-linear utility function.

Experimental Results: Discussed in this section are a number of utility experiments that were run on part of the live traffic. Each one was conducted over a period of a week. A fraction of browser cookies of users 214 were randomly, but consistently, assigned to an experiment. On average, the searches of about 200,000 distinct daily users were evaluated. The placement algorithm currently in use for production is similar to the placement algorithm described above, except that it already incorporates a heuristic discount for bad user experience. The present implementation of the quality score q is based on the model of clicks over expected clicks (COEC). The COEC is a display position-normalized CTR specific for a single ad that depends almost exclusively on the ad and its relation to the user query. More precisely, the NAP score may be computed as the estimated revenue, minus a parameter times the inverse COEC.

For additional explanation of COED and CTR, moving an ad from the East section to the North section would increase the CTR and click probability for this ad, but not change its COEC. Accordingly, COEC is comparable to clickability. Conversely, an absolute CTR is obtained for a certain ad shown at a certain position by multiplying the average CTR for that position with the COEC (or clickability) of the ad. By summing these probabilities for all ads shown on a given result page, an estimate of overall per-page CTR can be obtained. Accordingly:

CTR(ad, position)=AVG_CTR(position)*Clickability(ad);

Expected_Revenue(ad, position)˜bid(ad)*AVG_CTR(position)*Clickability(ad);

and

Expected_Revenue(page with given ad placement)=SUM_(all ads shown)*Expected_revenue(ad_{—}i, pos_{—}i) for subsequent ads (i) and positions (i).

Two threads of experiments were run. In the first one, different utility discounts were added to the NAP score based on a prediction of incremental North Ad Impact (NAI), in the spirit of Equation 4. A relevance model was trained to predict editorial rating, based on query/creative text overlap and click history features. For web relevance, a cache was used to store, for the most frequent queries, a single DCG-weighted average of the top five web search engine ranking scores. The second thread consisted of experiments with separate North and East auctions, as proposed above in Table 1. Different combinations of the click-through rate and relevance predictions were used to filter the candidates to be placed in the North ad slots.

TABLE 2

| | | | | | | CTR | | | | |
|---|---|---|---|---|---|---|---|---|---|---|
| Experiment | RPS | CTR | CY | PPC | NCTR | at 1N | Ncov | Ndep | NFP | wNFP |
| nai-norank | 1.3 | 0.6 | 0.9 | 0.3 | 0.7 | 0.6 | 0.3 | 0.3 | 0.6 | 0.5 |
| nai-rank | 1.3 | 0.5 | 0.7 | 0.6 | 7.6 | 4.6 | −6.2 | 8.2 | 1.5 | −1.0 |
| dual-cl | −2.4 | 1.4 | 1.3 | −3.6 | 3.6 | 2.8 | −1.3 | 2.1 | 0.7 | −0.1 |
| dual-ec | −2.2 | −0.4 | −0.4 | −1.8 | −1.4 | −1.6 | 0.1 | 1.5 | 1.6 | 1.0 |
| dual-cl-ec | −6.0 | −0.2 | −0.1 | −6.0 | 0.3 | −0.1 | −1.2 | 2.8 | 1.5 | 0.6 |
| dual-rel-0.3 | −1.0 | 0.0 | 0.2 | −1.2 | 1.5 | 1.2 | −1.5 | 1.0 | −0.5 | −0.8 |
| dual-rel-0.5 | −1.5 | 1.8 | 1.8 | −3.3 | 4.1 | 3.4 | −1.4 | 2.1 | 0.7 | 0.2 |
| dual-3thresh | −3.4 | 7.0 | 6.8 | −9.5 | 5.7 | 0.5 | 4.9 | 11.0 | 16.4 | 13.4 |

Table 2 gives a summary of the results. All numbers are percentage differences with respect to the current best algorithm candidate. The metrics are defined as follows: RPS—total revenue over total page views; CTR—total number of clicks over total number of page views with ads; CY—total clicks over total page views; PPC—average price per click; NCTR—CTR of all page views with North ads; Cov—ratio of page views that have ads; Ndep—average number of North ads in page views with any North ads; Ncov—ratio of page views that have North ads; Ndep—average number of North ads in page views with any North ads; NFP—average number of North ads per page view; wNFP—average DCG-weighted NFP.

The individual experiments, results of which are shown in Table 2, are explained in Table 3.

TABLE 3

| Experiment | Explanation |
|---|---|
| nai-discount | Add discount of the form param * (rel_{ad} − rel_{web}) to the NAP score. |
| dual-coec | Only ads whose COEC exceeded a certain threshold were allowed to be show |
| | in the North ad slots. |
| dual-ec | Only ads that had any historical click data stored on a certain aggregation level |
| | were allowed in the North ad slots. The reason is to take into account the |
| | confidence in the click prediction. |
| dual-coec-ec | This experiment combines the previous two: the condition for North ads is that |
| | the ad has a minimum COEC and historical information. |
| dual-rel-0.3 | North ads were required to pass at least one of a threshold on COEC and the |
| | estimated editorial relevance. |
| dual-rel-0.5 | Same as previous experiment, but with raised relevance threshold. |
| dual-3thresh | To be eligible for North placement, an ad has to pass at least one of three |
| | thresholds: on COEC, on relevance score, or on eCPM. Any placeable ad that |
| | fulfills this condition is automatically shown. |

The two NAI-based experiments show very similar, slight improvements in terms of the click and revenue metrics. However, note the significant change in NAP distribution: the rank-specific model shows North ads on fewer searches, but if it does, there are more on average. This is not surprising: since web relevance usually decreases with rank, the bar for the first rank is raised, while it is lowered for the last one.

In line with expectations, all of the dual-auction experiments (except dual-ec) lead to increased North CTR and lower RPS due to price drops. Similar to the NAI-based experiments, they change the NAP distribution towards lower North coverage and higher North depth. COEC-based filtering increases click yield reasonably, but the relevance model with the higher threshold (dual-rel-0.5) achieves similar click metrics with less revenue loss.

The idea of dual-coec-ec was to strengthen the criterion of dual-coec by additionally requiring a confidence in the COEC estimate, expressed as the availability of historical information. Note that in particular this will exclude newly created ads. Contrary to expectation, this led to a degradation in both click and revenue metrics. The negative effect is even more pronounced in the case that history alone (dual-ec) was used. This result can be interpreted in the way that some ads have a high CTR, despite being shown infrequently or being new, and that the click model provides a decent estimate for them.

The combination of the relevance, COEC, and revenue criteria (dual-3thresh) is the most disruptive. Note that while all other experiments were tuned to have roughly neutral NFP, this experiment increased the footprint. The idea was to absorb some of the revenue loss: presumably, if the shown ads are more relevant, we can afford to show more of them without impacting user experience. The CTR and click yield increase are highest for this experiment, and the simultaneous price drop should improve advertiser experience by providing them more clicks at a lower cost.

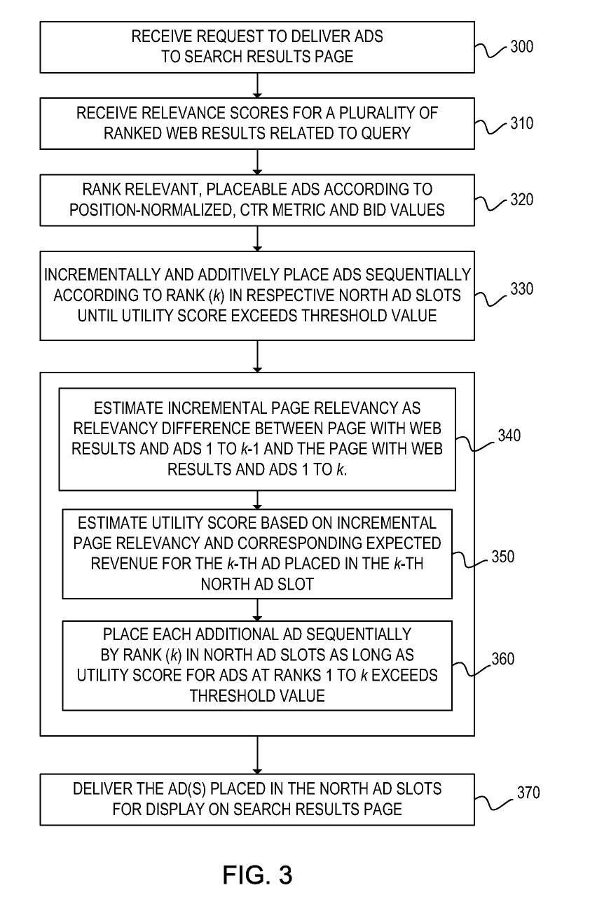

FIG. 3 is a flow diagram of an exemplary method for reducing ad impact on users in search advertising. The method is executable by the ad server 220 ha having a processor 244 and a memory 248 as follows. At block 310, the ad server 220 receives a request from a search engine 210 to deliver ads in response to a search query for display on a search results page 100. At block 320, the ad server 220 receives relevance scores for a plurality of ranked web results that are to be served to the search results page. At block 320, the processor ranks a plurality of ads identified as relevant to the search query according to a position-normalized, click-through-rate metric and bid values, wherein a predetermined number of the top-ranked ads are placeable in a plurality of North ad slots 112.

The processor incrementally and additively places the placeable ads sequentially according to rank (k) in their respective North ad slots until a utility score generated by a utility function for a current iteration of ads fails to exceed a threshold value according to the following steps. At block 340, the processor estimates an incremental page relevancy as a relevancy difference between a page displaying the ranked web results and ads at ranks 1 through k−1 with a page displaying the ranked web results and the ads at ranks 1 through k. At block 350, the processor estimates the utility score based on the incremental page relevancy and a corresponding expected revenue for the k-th ad placed in the k-th North ad slot. At block 360, the processor places each additional ad sequentially by rank (k) in a corresponding North ad slot as long as the utility score for displaying ads at ranks 1 through k exceeds the threshold value. At block 370, the ad server 220 delivers the placed ads to the search engine 210 for display in the North ads slots on the search results page.

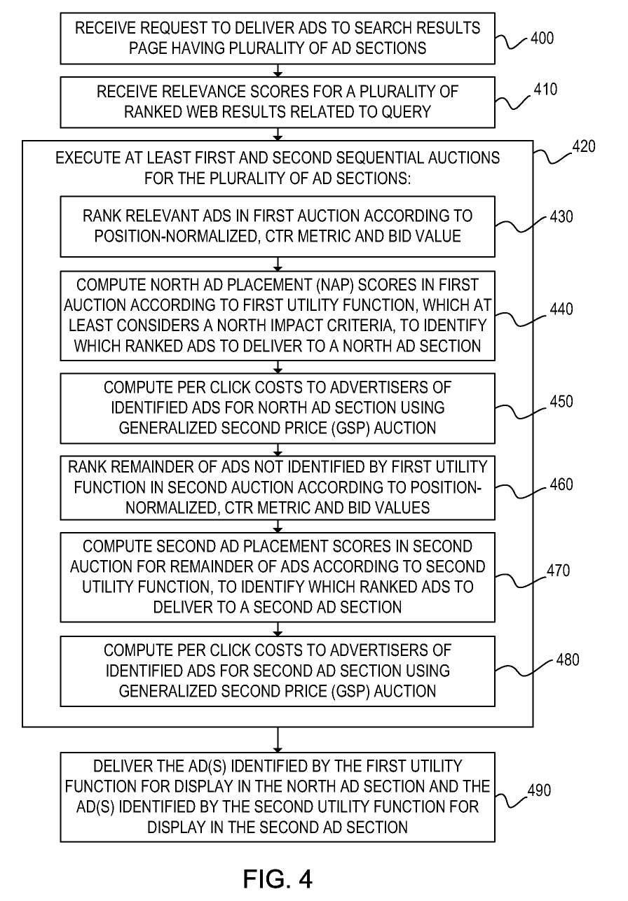

FIG. 4 is a flow diagram of an exemplary method for executing multiple auctions on advertisements (“ad”) 104 to be served to a search results page 100. The method is executable by the ad server 220 having a processor 244 and a memory 248 as follows. At block 400, the ad server 220 receives a request from a search engine 210, to deliver ads 104 in response to a search query for display on a search results page. At block 410, the ad server 220 receives from the search engine 210 relevance scores for a plurality of ranked web results that are to be served to the search results page. The search results page includes a plurality of ad sections for display of the ads, including a North ad section 112.

At block 420, the processor performs at least first and second sequential auctions for the plurality of ad sections, which includes, at block 430, to rank the ads in the first auction by executing a first utility function on the ads to identify which of the ads to deliver to the North ad section and at what rank. The first utility function considers criteria related to impact of the ads on a relevance of the search results page if delivered to the North ad section. At block 440, the processor computes costs to advertisers of the identified ads for delivery to the North ad section using a generalized second price auction. At block 450, the processor ranks a remainder of the ads not identified for display in the North ad section in the second auction by executing a second utility function, different than the first utility function, on the remainder of the ads to identify which of the remainder of the ads to display in at least a second ad section and at what rank. At block 460, the processor computes costs to advertisers of the identified ads for delivery to the second ad section using a generalized second price auction. At block 470, the ad server 220 delivers to the search engine 210 the ads identified by the first utility function for display in ad slots of the North ad section and the ads identified by the second utility function for display in ad slots of the second ad section.

Disclosed include some formalisms to describe utility functions for search ad systems. While these formalisms are often hard to implement and hidden parameters are not easily estimable, there exist feasible special cases. In particular, in this paper has been shown that building and using models to predict North Ad Impact (NAI), as well as performing separate auctions for the North and East regions of the search results page, can lead to encouraging metrics such as an increase in total clicks.

The system and methods described may be encoded in a signal bearing medium, a computer-readable medium such as a memory, programmed within a device such as one or more integrated circuits, one or more processors or processed by a controller or a computer. If the methods are performed by software, the software may reside in a memory resident to or interfaced to a storage device, synchronizer, a communication interface, or non-volatile or volatile memory in communication with a transmitter. A circuit or electronic device may be designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for reducing ad impact on users in search advertising, thereby improving page relevancy of a search results page, the method executed by an advertising (ad) server having a processor and memory, the method comprising:
receiving a request, by the ad server from a search engine, to deliver ads in response to a search query for display on a search results page;
receiving, by the ad server from the search engine, relevance scores for a plurality of ranked web results that are to be served to the search results page;
ranking, by the processor, a plurality of ads identified as relevant to the search query according to a position-normalized, click-through-rate metric and bid values, wherein a predetermined number of the top-ranked ads are placeable in a plurality of North ad slots;
incrementally and additively placing, by the processor, the placeable ads sequentially according to rank (k) in their respective North ad slots until a utility score generated by a utility function for a current iteration of ads fails to exceed a threshold value, wherein placing comprises:
estimating an incremental page relevancy as a relevancy difference between a page displaying the ranked web results and ads at ranks 1 through k−1 with a page displaying the ranked web results and the ads at ranks 1 through k;
estimating the utility score based on the incremental page relevancy and a corresponding expected revenue for the k-th ad placed in the k-th North ad slot; and
placing each additional ad sequentially by rank (k) in a corresponding North ad slot as long as the utility score for displaying ads at ranks 1 through k exceeds the threshold value; and
delivering, by the ad server to the search engine for display in the North ads slots on the search results page, the ads placed in the North ad slots.

2. The method of claim 1, wherein when no iteration of placement of the ads produces a utility score above the threshold value, the method further comprising:
delivering no ad for display in the North ad slots.

3. The method of claim 1, wherein estimating the expected revenue of a ad comprises multiplying a probability of receiving a user click by a bid value for the ad and wherein the incremental page relevancy is estimated using discounted cumulative gain (DCG) as the web results are pushed down a slot for each additional ad that is placed in the North ad slots.

4. The method of claim 1, wherein the utility function uses an incremental North Ad Impact (NAIₖ) value for each iteration of ads placed in the North ad slots, each NAIₖ estimated by pushing down the plurality of web results a rank with each additional ad that is placed, wherein NAIₖ is estimated as ωₖ(rel_{web}−rel_{ad,k}), where ωₖ comprises a rank-based weight, rel_{web} is the editorial relevance of the search results page with only web results and rel_{ad,k} is the editorial relevance of the search results page with the ads of each iteration placed in the North ad slots followed by the web results.

5. The method of claim 4, wherein the utility function subtracts from the expected revenue the NAI multiplied by a scaling factor to estimate the utility score.

6. The method of claim 4, the method further comprising:
adjusting the threshold value to increase or decrease the number of ads delivered to the North ad slots, to maximize revenue under a constraint of a maximum average NAI.

7. The method of claim 6, wherein the utility score comprises a ratio of the expected revenue divided by the estimated NAI, wherein the placeable ads are continued to be placed in North ad slots as long as the utility score exceeds the threshold value.

8. The method of claim 1, further comprising:
placing in an East ad section the ads that are placeable in the North ad slots but which are not placed there based on the utility score failing to exceed the threshold value.

9. A system for reducing ad impact on users in search advertising, thereby improving page relevancy of a search results page, the method comprising:
an ad server having a processor and a system memory, the ad server to receive a request from a search engine to deliver ads in response to a search query for display on a search results page, and to receive relevance scores for a plurality of ranked web results that are to be served to the search results page;
wherein the processor is configured to:
rank a plurality of ads identified as relevant to the search query according to a position-normalized, click-through-rate metric and bid values, wherein a predetermined number of the top-ranked ads are placeable in a plurality of North ad slots;
incrementally and additively place the placeable ads sequentially according to rank (k) in their respective North ad slots until a utility score generated by a utility function for a current iteration of ads fails to exceed a threshold value, comprising:
estimating an incremental page relevancy as a relevancy difference between a page displaying the ranked web results and ads at ranks 1 through k−1 with a page displaying the ranked web results and the ads at ranks 1 through k;
estimating the utility score based on the incremental page relevancy and a corresponding expected revenue for the k-th ad placed in the k-th North ad slot; and
placing each additional ad sequentially by rank (k) in a corresponding North ad slot as long as the utility score for displaying ads at ranks 1 through k exceeds the threshold value; and
wherein the ad server delivers the ads placed in the North ad slots to the search engine for display in the North ads slots of the search results page.

10. The system of claim 9, wherein when no iteration of placement of the ads produces a utility score above the threshold value, the ad server delivers no ad for display in the North ad slots.

11. The system of claim 9, wherein estimating the expected revenue of a ad comprises multiplying a probability of receiving a user click by a bid value for the ad and wherein the incremental page relevancy is estimated using discounted cumulative gain (DCG) as the web results are pushed down a slot for each additional ad that is placed in the North ad slots.

12. The method of claim 9, wherein the utility function uses an incremental North Ad Impact (NAIₖ) value for each iteration of ads placed in the North ad slots, each NAIₖ estimated by pushing down the plurality of web results a rank with each additional ad that is placed, wherein NAIₖ is estimated as ωₖ(rel_{web}−rel_{ad,k}), where ωₖ comprises a rank-based weight, rel_{web} is the editorial relevance of the search results page with only web results and rel_{ad,k} is the editorial relevance of the search results page with the ads of each iteration placed in the North ad slots followed by the web results.

13. The system of claim 12, wherein the utility function subtracts from the expected revenue the NAI multiplied by a scaling factor to estimate the utility score.

14. The system of claim 13, wherein the processor is further configured to adjust the threshold value to increase or decrease the number of ads delivered to the North ad slots, to maximize revenue under a constraint of a maximum average NAI.

15. The system of claim 14, wherein the utility score comprises a ratio of the expected revenue divided by the estimated NAI, wherein the placeable ads are continued to be placed in North ad slots as long as the utility score exceeds the threshold value.

16. The system of claim 9, wherein the processor is further configured to place in an East ad section the ads that are placeable in the North ad slots but which are not placed there based on the utility score failing to exceed the threshold value.

17. A computer-readable storage medium comprising a set of instructions for reducing ad impact on users in search advertising, thereby improving page relevancy of a search results page, the set of instructions to direct a processor to perform the acts of:
receiving a request, by an ad server from a search engine, to deliver ads in response to a search query for display on a search results page;
receiving, by the ad server from the search engine, relevance scores for a plurality of ranked web results that are to be served to the search results page;
ranking, by the processor, a plurality of ads identified as relevant to the search query according to a position-normalized, click-through-rate metric and bid values, wherein a predetermined number of the top-ranked ads are placeable in a plurality of North ad slots;
incrementally and additively placing, by the processor, the placeable ads sequentially according to rank (k) in their respective North ad slots until a utility score generated by a utility function for a current iteration of ads fails to exceed a threshold value, wherein placing comprises:
estimating an incremental page relevancy as a relevancy difference between a page displaying the ranked web results and ads at ranks 1 through k−1 with a page displaying the ranked web results and the ads at ranks 1 through k;
estimating the utility score based on the incremental page relevancy and a corresponding expected revenue for the k-th ad placed in the k-th North ad slot; and
placing each additional ad sequentially by rank (k) in a corresponding North ad slot as long as the utility score for displaying ads at ranks 1 through k exceeds the threshold value; and
delivering, by the ad server to the search engine for display in the North ads slots on the search results page, the ads placed in the North ad slots.

18. The computer-readable storage medium of claim 17, wherein when no iteration of placement of the ads produces a utility score above the threshold value, further comprising a set of instructions to direct a processor to perform the acts of:
delivering no ad for display in the North ad slots.

19. The computer-readable storage medium of claim 17, wherein estimating the expected revenue of a ad comprises multiplying a probability of receiving a user click by a bid value for the ad and wherein the incremental page relevancy is estimated using discounted cumulative gain (DCG) as the web results are pushed down a slot for each additional ad that is placed in the North ad slots.

20. The computer-readable storage medium of claim 17, wherein the utility function uses an incremental North Ad Impact (NAIₖ) value for each iteration of ads placed in the North ad slots, each NAIₖ estimated by pushing down the plurality of web results a rank with each additional ad that is placed, wherein NAIₖ is estimated as ωₖ(rel_{web}−rel_{ad,k}), where ωₖ comprises a rank-based weight, rel_{web} is the editorial relevance of the search results page with only web results and rel_{ad,k} is the editorial relevance of the search results page with the ads of each iteration placed in the North ad slots followed by the web results.

21. The computer-readable storage medium of claim 20, wherein the utility function subtracts from the expected revenue the NAI multiplied by a scaling factor to estimate the utility score.

22. The computer-readable storage medium of claim 20, further comprising a set of instructions to direct a processor to perform the acts of:
adjusting the threshold value to increase or decrease the number of ads delivered to the North ad slots, to maximize revenue under a constraint of a maximum average NAI.

23. The computer-readable storage medium of claim 22, wherein the utility score comprises a ratio of the expected revenue divided by the estimated NAI, wherein the placeable ads are continued to be placed in North ad slots as long as the utility score exceeds the threshold value.

24. The computer-readable storage medium of claim 17, further comprising a set of instructions to direct a processor to perform the acts of:
placing in an East ad section the ads that are placeable in the North ad slots but which are not placed there based on the utility score failing to exceed the threshold value.
